(19) United States
(12) Patent Application Publication
(10) Pub. No.: US 2007/0139673 A1
(43) Pub. Date: Jun. 21, 2007

(54) Image processing system and method

(75) Inventors: Satoshi Tanaka, Kanagawa (JP); Matsuyuki Aoki, Kanagawa (JP); Hideki Kimura, Kanagawa (JP); Shinsuke Sugi, Kanagawa (JP); Hiroyoshi Uejo, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/437,909

(22) Filed: May 22, 2006

(30) Foreign Application Priority Data
Dec. 16, 2005 (JP) 2005-362998

(51) Int. Cl. H04N 1/60

(52) U.S. Cl. 358/1.9; 358/1.4

(57) ABSTRACT

An image processing system includes: a separator that separates an input image signal including plural color signals to each color corresponding to a marking engine of each color and outputs a color signal of each color; an acquiring part that acquires contents of the plural color signals forming each pixel from the input image signal; and a setting part that sets an image forming condition for each color by using the color signal of each color outputted from the separator and the contents of the plural color signals outputted from the acquiring part.

This application claims the benefit of Japanese Patent Application No. 2005-362998 filed in Japan on Dec. 16, 2005, which is hereby incorporated by reference.

### BACKGROUND

1. Technical Field

This invention relates to an image processing system and method that perform processing on an image signal of each color for forming an image and thus carry out color correction.

2. Related Art

Recently, for an image forming apparatus such as printer, copying machine or facsimile, a so-called full-color tandem machine has been proposed in order to form a color image of high image quality at a high speed. In a typical such tandem machine, four image forming units of yellow (Y), magenta (M), cyan (C) and black (K) are arranged parallel to each other. In this image forming apparatus, toner images of yellow, magenta, cyan and black that are sequentially formed by the respective image forming units are sequentially transferred onto an intermediate transfer belt (first transfer). After that, one-shot transfer (second transfer) from the intermediate transfer belt to a paper is performed and the toner image formed on the paper is fixed by a fixing device, thereby providing a full-color or monochrome image.

In such an image forming apparatus, to perform first transfer, a first transfer bias is applied between a photoconductor drum provided on each image forming unit and a first transfer device (for example, first transfer roll) arranged to face each photoconductor drum via the intermediate transfer belt, thus transferring the toner on each photoconductor drum to the intermediate transfer belt. Here, if the first transfer bias is insufficient, a part of the toner on the photoconductor drum is not transferred to the intermediate transfer belt and the toner density on the intermediate transfer belt is lowered. On the other hand, if the first transfer bias is excessive, a so-called re-transfer phenomenon occurs in which the toner once transferred from the photoconductor drum onto the intermediate transfer belt is transferred back to the photoconductor drum. Therefore, again, the toner density on the intermediate transfer belt is lowered.

In the image forming apparatus of this type, for example, to form a red image, a toner image of yellow is formed on the intermediate transfer belt and then a toner image of magenta is superposed onto the yellow toner image on the intermediate transfer belt. The superposed toner images of yellow and magenta on the intermediate transfer belt are second-transferred to a paper and then mixed with each other when they are melted by heating by a fixing device, thus providing a red image. Here, if the above-described insufficient transfer or excessive transfer occurs in the yellow or magenta image forming unit, the coloring of the resulting image differs from the originally intended coloring. That is, in the case of forming a multiple-color by superposing plural color component toners, even if inputs of the respective colors (for example, yellow and magenta) forming the multiple-color in the image forming units are the same, the density of the toner image of each color that is first-transferred to the intermediate transfer belt varies, the coloring balance of the resulting output (image) is lost.

Moreover, in this image forming apparatus, to form a full-color image, for example, a magenta toner image is first-transferred onto the intermediate transfer belt on which a yellow toner image has already been first-transferred. A cyan toner image is first-transferred onto the intermediate transfer belt on which the yellow and magenta toner images have already been first-transferred. A black toner image is first-transferred onto the intermediate transfer belt on which the yellow, magenta and cyan toner images have already been transferred. Here, for example, the yellow toner image first-transferred on the intermediate transfer belt passes later through the facing parts to the image forming units (photoconductor drums) of magenta, cyan and black. In this case, a part of the yellow toner on the intermediate transfer belt may be transferred to the photoconductor drums of magenta, cyan and black. Then, the density of the yellow toner image on the intermediate transfer belt is lowered and it leads to the lost coloring balance in the resulting output.

In this manner, in the image forming apparatus of this type, the relation between the input and output of each color when forming a multiple-color changes non-linearly. Thus, to correct such deviation, there is a technique of setting the input value of each color in accordance with each output by using a multi-dimensional lookup table (or direct lookup table (DLUT)) associating the input and output. By performing correction using such DLUT, it is possible to perform highly accurate correction and to restrain coloring deviation in the image as described above.

### SUMMARY

According to an aspect of this invention, an image processing system includes: a separator that separates an input image signal including plural color signals to each color corresponding to a marking engine of each color and outputs a color signal of each color; an acquiring part that acquires contents of plural color signals forming each pixel from the input image signal; and a setting part that sets an image forming condition for each color by using the color signal of each color outputted from the separator and the contents of the plural color signals outputted from the acquiring part.

### BRIEF DESCRIPTION OF THE DRAWINGS

Exemplary embodiments of the invention will be described in detail based on the following figures, wherein:

FIG. 1 shows a configuration of an image forming apparatus according to an exemplary embodiment of this invention;

FIG. 2 is a block diagram showing an image processing system in the image forming apparatus;

FIG. 3 is a block diagram for explaining a detailed configuration of a yellow lookup table (Y-LUT);

FIGS. 4A to 4D show examples of four LUTs stored in a LUT storage of the Y-LUT;

FIGS. 5A to 5D show examples of four LUTs stored in a LUT storage of an M-LUT;

FIG. 6 is a flowchart for explaining a processing flow in an image information judging part in a first exemplary embodiment;

FIG. 7 shows an example of image signal inputted from an image output part to an image processing part;

FIG. 8 is a flowchart for explaining a processing flow in an image information judging part in a second exemplary embodiment; and

FIG. 9 is a flowchart for explaining a processing flow in an image information judging part in a third exemplary embodiment.

### DETAILED DESCRIPTION

Exemplary embodiments of this invention will now be described in detail with reference to the drawings.

### First Exemplary Embodiment

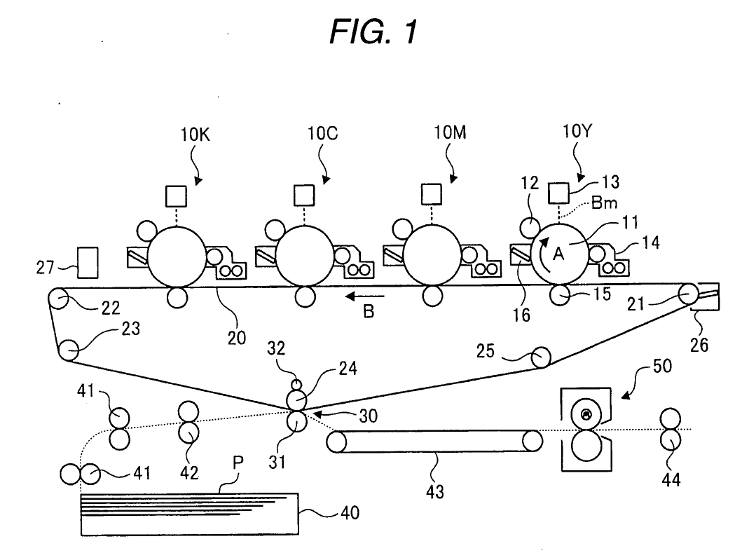

FIG. 1 shows a schematic configuration of an image forming apparatus according to a first exemplary embodiment. This image forming apparatus has plural (in this exemplary embodiment, four) image forming units 10 (specifically, 10Y for yellow, 10M for magenta, 10C for cyan and 10K for black) in which toner images of the respective color components are formed, for example, by an electrophotographic system. The image forming apparatus also has an intermediate transfer belt 20 to which the toner images of the respective color components formed in the respective image forming units 10 are sequentially transferred (first transfer) and held thereon. Here, the image forming units 10 as a kind of marking engines are arranged in the order of the yellow image forming unit (yellow unit) 10Y, the magenta image forming unit (magenta unit) 10M, the cyan image forming unit (cyan unit) 10C and the black image forming unit (black unit) 10K, from upstream in the turning direction of the intermediate transfer belt 20. The image forming apparatus also has a second transfer device 30 that transfers the superposed images that have been transferred on the intermediate transfer belt 20 to a paper P in one shot (second transfer). The image forming apparatus also has a fixing device 50 that fixes the second-transferred image onto the paper P.

The image forming units 10 (10Y, 10M, 10C and 10K) have the same configuration except for the colors of the toners that they use. Thus, the yellow unit 10Y will now be described as an example. The yellow unit 10Y has a photoconductor drum 11 having a photosensitive layer, not shown, and arranged to be rotatable in the direction of arrow A. A charging roll 12, an exposure part 13, a developer 14, a first transfer roll 15 and a drum cleaner 16 are arranged around this photoconductor drum 11. Of these parts, the charging roll 12 is arranged rotatably in contact with the photoconductor drum 11 and charges the photoconductor drum 11 to a predetermined potential. The exposure part 13 writes, by a laser beam Bm, an electrostatic latent image to the photoconductor drum 11 charged to the predetermined potential by the charging roll 12. The developer 14 houses the toner of the corresponding color components (yellow toner in the yellow unit 10Y) and develops the electrostatic latent image on the photoconductor drum 11 by using the toner. The first transfer roll 15 performs first transfer of the toner image formed on the photoconductor drum 11 to the intermediate transfer belt 20 by a first transfer bias thereto. The drum cleaner 16 eliminates residuals (toner and the like) on the photoconductor drum 11 after the first transfer.

The intermediate transfer belt 20 is tensely supported to be turnable by plural (in this exemplary embodiment, five) supporting rolls and turns in the direction of arrow B. Of these supporting rolls, a driving roll 21 tensions the intermediate transfer belt 20 and drives the intermediate transfer belt 20 to turn. Follower rolls 22 and 25 tension the intermediate transfer belt 20 and turn by following the intermediate transfer belt 20 driven by the driving roll 21. A correction roll 23 tensions the intermediate transfer belt 20 and functions as a steering roll (arranged to freely incline about one end part in the axial direction as a supporting point) that regulates meandering of the intermediate transfer belt 20 in a direction substantially orthogonal to the transport direction. Moreover, a backup roll 24 tensions the intermediate transfer belt 20 and functions as a component member of the second transfer device 30, which will be described later.

At a position facing the driving roll 21 via the intermediate transfer belt 20, a belt cleaner 26 is arranged that eliminates residuals (toner and the like) on the intermediate transfer belt 20 after the second transfer. A density sensor 27 is arranged to face the intermediate transfer belt 20. The density sensor 27 is arranged near the black unit 10K. The density sensor 27 reads the toner image of each color that has been first-transferred onto the intermediate transfer belt 20 and detects its density.

The second transfer device 30 has a second transfer roll 31 pressed in contact with a toner image carrying side of the intermediate transfer belt 20, and the backup roll 24 arranged on a rear side of the intermediate transfer belt 20 and forming the counter-electrode to the second transfer roll 31. A power feed roll 32 that applies a second transfer bias of the same polarity as the charging polarity of the toner is abutted against the backup roll 24. On the other hand, the second transfer roll 31 is grounded.

A paper transporting system has a paper tray 40, a transport roll 41, a registration roll 42, a transport belt 43 and a discharge roll 44. In the paper transporting system, the paper P loaded on the paper tray 40 is transported by the transport roll 41. After that, the paper P is temporarily stopped by the registration roll 42 and then sent to a second transfer position in the second transfer device 30 at predetermined timing. The paper P after the second transfer is transported to the fixing device 50 via the transport belt 43, and the paper P discharged from the fixing device 50 is sent out of the machine by the discharge roll 44.

Next, a basic image forming process in this image forming apparatus will be described. If a start switch, not shown, is turned on now, a predetermined image forming process will be executed. Specifically, for example, in the case where the image forming apparatus is configured as a printer, digital image signals inputted from outside, for example, from a personal computer (PC) or the like, are temporarily stored into a memory. Then, toner images of respective colors are formed on the basis of the digital image signals of four colors (Y, M, C and K) stored in the memory. That is, the image forming units 10 (specifically, 10Y, 10M, 10C and 10K) are driven in accordance with the digital image signals of the respective colors. Next, in each image forming unit 10, the photoconductor drum 11 uniformly charged by the charging roll 12 is irradiated with a laser beam Bm corresponding the digital image signal by the exposure part 13, thereby forming an electrostatic latent image. The electrostatic latent image formed on the photoconductor drum 11 is developed by the developer 14, thus forming a toner image of each color. Meanwhile, if the image forming apparatus is configured as a copying machine, a document set on a document table, not shown, is read by a scanner. The resulting read signal is converted to a digital image signal by a processing circuit and then a toner image of each color is formed in the same manner as described above.

After that, the toner image formed on each photoconductor drum 11 is sequentially first-transferred onto the surface of the intermediate transfer belt 20 by the first transfer roll 15 at the first transfer position where the photoconductor drum 11 contacts the intermediate transfer belt 20. The toner remaining on the photoconductor drum 11 after the first transfer is eliminated by the drum cleaner 16.

The toner images thus first-transferred to the intermediate transfer belt 20 are superposed on the intermediate transfer belt 20 and carried to the second transfer position by the turning of the intermediate transfer belt 20. The paper P is transported to the second transfer position at predetermined timing, and the second transfer roll 31 and the backup roll 24 nip the paper P.

Then, at the second transfer position, the toner image carried on the intermediate transfer belt 20 is second-transferred to the paper P by the action of a transfer field formed between the second transfer roll 31 and the backup roll 24. The paper P to which the toner image has been transferred is transported to the fixing device 50 by the transport belt 43. In the fixing device 50, the toner image on the paper P is fixed by being heated and pressurized. After that, the paper P is sent out to an ejected paper tray (not shown) provided outside the machine. The toner remaining on the intermediate transfer belt 20 after the second transfer is eliminated by the belt cleaner 26.

Meanwhile, for typical image forming apparatuses, the color reproducibility differs from apparatus to apparatus. That is, if the same digital image signal is inputted to plural image forming apparatuses and image formation is performed in each image forming apparatus by using this digital image signal, the coloring of an image outputted from each image forming apparatus differs. Particularly, in an image forming apparatus of a type that superposes toner images of respective colors by transfer and thus forms a full-color image as in this exemplary embodiment, the density of the toner formed on the intermediate transfer belt 20 is lowered by insufficient transfer or excessive transfer when transferring each color (first transfer). Therefore, the coloring of the outputted image tends to deviate from desired coloring.

Thus, in this exemplary embodiment, in consideration of such variance in the toner density in the transfer, so-called color conversion processing to convert an incoming color signal of each color to an image recording signal corresponding to the color reproducibility of this image forming apparatus is performed, thus restraining deviation of the coloring.

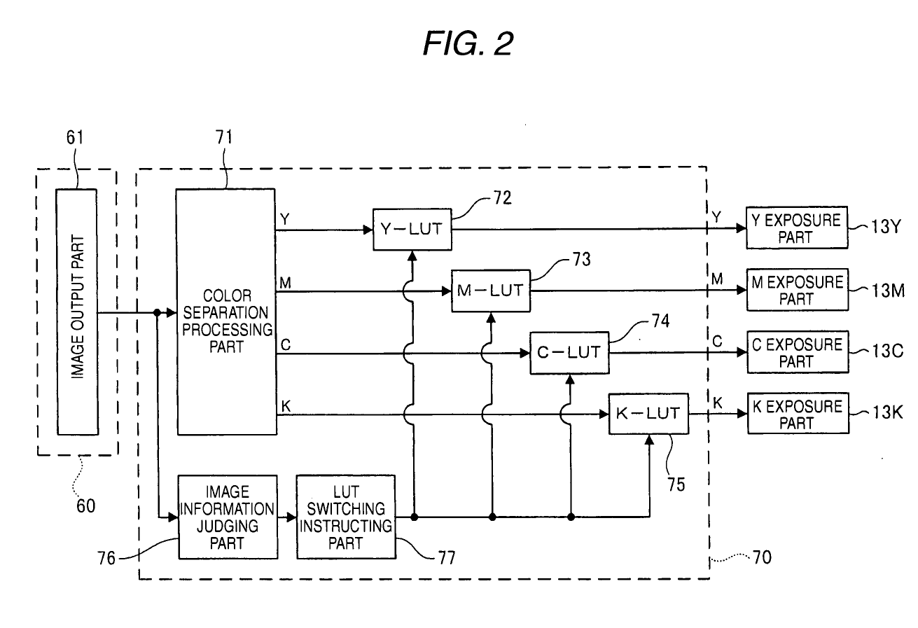

FIG. 2 is a block diagram showing an image processing system in this image forming apparatus. In this example, the image forming apparatus is configured as a printer. This signal processing system has a personal computer (PC) 60 provided outside of the image forming apparatus, and an image processing part 70 provided within the image forming apparatus.

The PC 60 has an image output part 61 that outputs an image signal to be printed out. In this exemplary embodiment, the image output part 61 outputs an image signal having an address appended to each pixel (dot). The image signal of each address contains density information of yellow, magenta, cyan and black. That is, this image signal, which is an input image signal, contains plural color signals. This image signal will be later described specifically.

The image processing part 70 has a color separation processing part 71, a yellow lookup table (Y-LUT) 72, a magenta lookup table (M-LUT) 73, a cyan lookup table (C-LUT) 74, a black lookup table (K-LUT) 75, an image information judging part 76, and a LUT switching instructing part 77.

Of these, the color separation processing part 71 as a color separator separates an image signal inputted form the image output part 61 of the PC 60 into image signals (color signals) of yellow, magenta, cyan and black. In this case, the color separation processing part 71 adds the appended addresses to the separated image signals of yellow, magenta, cyan and black, and thus outputs these image signals.

The Y-LUT 72 performs color conversion processing on the yellow image signal inputted form the color separation processing part 71 by using a lookup table (LUT) and outputs the color-converted signal to the exposure part (Y exposure part) 13Y of the yellow unit 10Y. The M-LUT 73 performs color conversion processing on the magenta image signal inputted form the color separation processing part 71 by using a lookup table (LUT) and outputs the color-converted signal to the exposure part (M exposure part) 13M of the magenta unit 10M. The C-LUT 74 performs color conversion processing on the cyan image signal inputted form the color separation processing part 71 by using a lookup table (LUT) and outputs the color-converted signal to the exposure part (C exposure part) 13C of the cyan unit 10C. The K-LUT 75 performs color conversion processing on the black image signal inputted form the color separation processing part 71 by using a lookup table (LUT) and outputs the color-converted signal to the exposure part (K exposure part) 13K of the black unit 10K. Each of these Y-LUT 72, M-LUT 73, C-LUT 74 and K-LUT 75 functioning as setting parts or converting parts has plural LUTs and switches the LUT to be used (predetermined parameter) in accordance with an instruction from the LUT switching instructing part 77. This will be described in detail later.

The image information judging part 76 functioning as an acquiring part judges the contents of image information of the pixel of each address on the basis of the image signal inputted thereto from the image output part 61 of the PC 60, that is, the image signal that has not been color-separated. Here, in this exemplary embodiment, the image information judging part 76 judges how many colors are used for forming each pixel, as the contents of the image information. In the following description, if a pixel contains a single color of yellow, magenta, cyan or black, the color is called first color. Similarly, if a pixel contains two of these colors, the resulting color is called second color. If a pixel contains three of these colors, the resulting color is called third color. If a pixel contains all these colors, that is, four colors, the resulting color is called fourth color.

The LUT switching instructing part 77 functioning as a switcher determines the LUT to be used in the Y-LUT 72, M-LUT 73, C-LUT 74 and K-LUT 75 for each pixel (each address) on the basis of the result of judging the contents of the image information by the image information judging part 76. That is, the LUT switching instructing part 77 determines the LUT to be used, depending on whether each pixel has a first color, second color, third color or fourth color. Then, the LUT switching instructing part 77 outputs an instruction signal associating the address of the pixel with the determined LUT to the Y-LUT 72, M-LUT 73, C-LUT 74 and K-LUT 75.

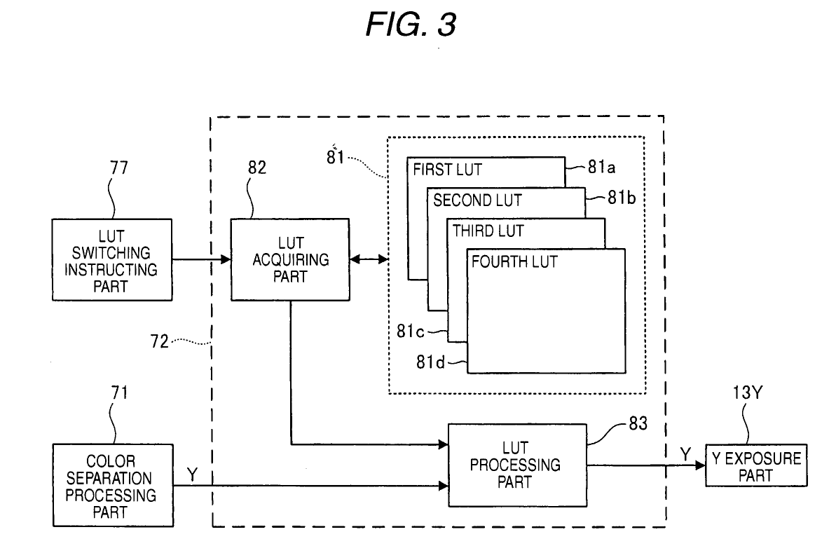

FIG. 3 is a block diagram for explaining a detailed configuration of the Y-LUT 72, of the above-described Y-LUT 72, M-LUT 73, C-LUT 74 and K-LUT 75. The M-LUT 73, C-LUT 74 and K-LUT 75 have the same configuration as the Y-LUT 72.

The Y-LUT 72 has a LUT storage 81, a LUT acquiring part 82, and a LUT processing part 83.

In this exemplary embodiment, the LUT storage 81 stores plural LUTs (in this exemplary embodiment, four LUTs). Of these plural LUTs, the first LUT 81a is used when a pixel contains a first color. The second LUT 81b is used when a pixel contains a second color. The third LUT 81c is used when a pixel contains a third color. The fourth LUT 81d is used when a pixel contains a fourth color.

The LUT acquiring part 82 acquires a LUT (one of the first to fourth LUTs 81a to 81d) designated for each pixel on the basis of an instruction from the LUT switching instructing part 77 and outputs the acquired LUT to the LUT processing part 83.

To the LUT processing part 83, the yellow image signal is inputted from the color separation processing part 71, and the LUT acquired from the LUT storage 81 on the basis of the instruction from the LUT switching instructing part 77 is inputted from the LUT acquiring part 82. The LUT processing part 83 performs color conversion processing on the yellow image signal having a predetermined address by using the LUT having the same address appended thereto, and outputs the color-converted signal to the Y exposure part 13Y.

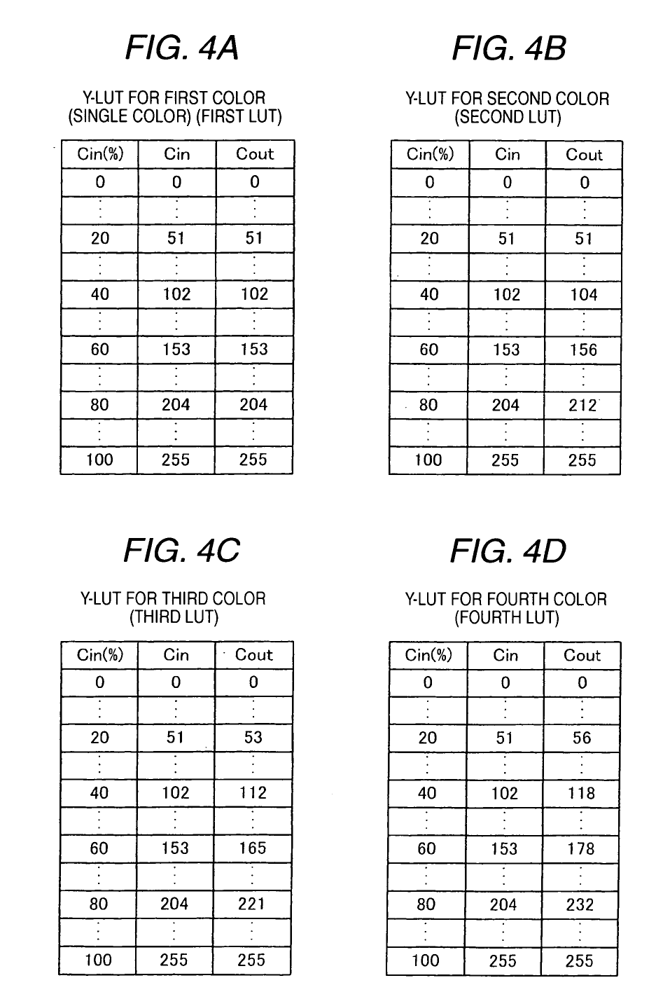

FIGS. 4A to 4D show examples of the plural LUTs stored in the LUT storage 81 of the Y-LUT 72. FIG. 4A shows the LUT for first color (first LUT 81a). FIG. 4B shows the LUT for second color (second LUT 81b). FIG. 4C shows the LUT for third color (third LUT 81c). FIG. 4D shows the LUT for fourth color (fourth LUT 81d). Each LUT is a table in which input coverage Cin (having 8 bits, that is, 256 gradation levels (that can take values of 0 to 255)) expressing input coverage Cin (0 to 100%) by gradation level and output coverage Cout (similarly having 8 bits, that is, 256 gradation levels (that can take values of 0 to 255)) are associated one to one. The relation between the input coverage Cin and the output coverage Cout slightly differs among the first color, second color, third color and fourth color.

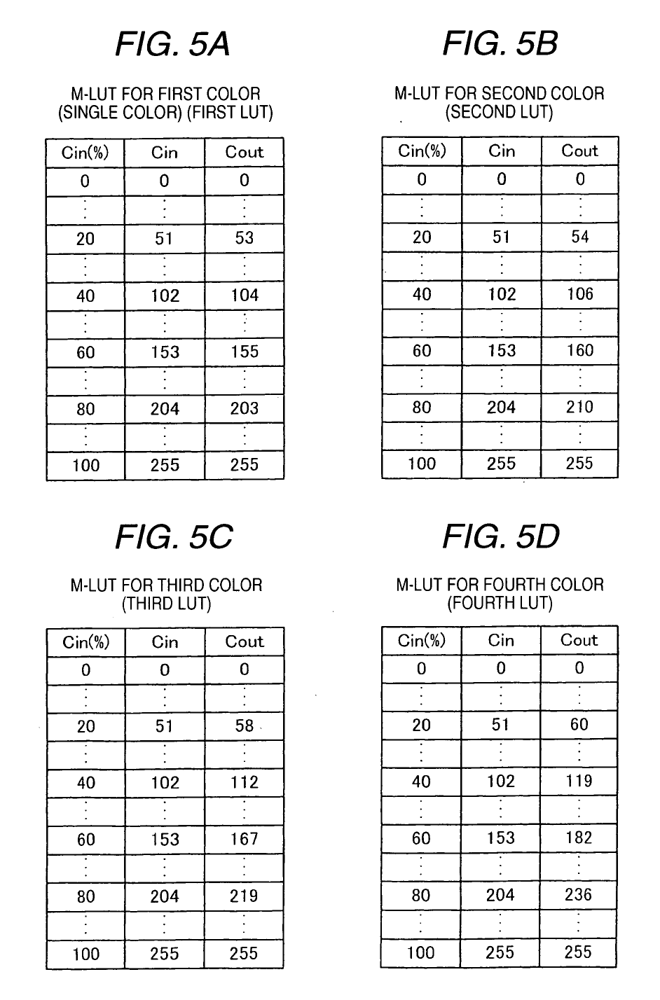

FIGS. 5A to 5D show examples of the plural LUTs stored in the LUT storage 81 of the M-LUT 73. FIG. 5A shows the LUT for first color (first LUT 81a). FIG. 5B shows the LUT for second color (second LUT 81b). FIG. 5C shows the LUT for third color (third LUT 81c). FIG. 5D shows the LUT for fourth color (fourth LUT 81d). As in the case of yellow, each LUT is a table in which input coverage Cin (having 8 bits, that is, 256 gradation levels (that can take values of 0 to 255)) expressing input coverage Cin (0 to 100%) by gradation level and output coverage Cout (similarly having 8 bits, that is, 256 gradation levels (that can take values of 0 to 255)) are associated one to one. The relation between the input coverage Cin and the output coverage Cout slightly differs among the first color, second color, third color and fourth color. Also, as is clear from the relations with FIGS. 4A to 4D, for example, if the two LUTs for fourth colors (fourth LUTs 81d) are compared with each other, the relation between the input coverage Cin and the output coverage Cout slightly differs between yellow and magenta. The LUTs for first color, second color, third color and fourth color are stored in the LUT storage 81 of the C-LUT 74 and the LUT storage 81 of the K-LUT 75.

Next, the operation of the image processing part 70 in the image forming operation will be described. First, an image signal (color image signal) is inputted to the image processing part 70 from the image output part 61 of the PC 60. Then, the color separation processing part 71 performs color separation of the inputted image signal for each address and outputs the color-separated yellow image signal, magenta image signal, cyan image signal and black image signal to the Y-LUT 72, M-LUT 73, C-LUT 74 and K-LUT 75.

Meanwhile, the image information judging part 76 judges how many colors are used for forming the inputted image signal for each address, and outputs the result of the judgment to the LUT switching instructing part 77. The LUT switching instructing part 77 determines which LUT should be used (one of the first to fourth LUTs 81a to 81d) in the Y-LUT 72, M-LUT 73, C-LUT 74 and K-LUT 75 on the basis of the incoming result of the judgment, and outputs the determined LUT to the Y-LUT 72, M-LUT 73, C-LUT 74 and K-LUT 75.

For example, in the Y-LUT 72, the LUT acquiring part 82 acquires the corresponding LUT from the LUT storage 81 in accordance with an instruction signal inputted from the LUT switching instructing part 77, and outputs the acquired LUT to the LUT processing part 83. On the other hand, a yellow image signal (Cin) is inputted from the color separation processing part 71 to the LUT processing part 83. After that, in the Y-LUT 72, area coverage conversion is performed to the yellow image signal (Cin) by using the LUT having the same address, and the color-converted yellow image signal (Cout) is outputted. In the M-LUT 73, C-LUT 74 and K-LUT 75 other than the Y-LUT 72, the processing similar to the processing in the Y-LUT 72 is performed and the area coverage-converted magenta image signal (Cout), cyan image signal (Cout) and black image signal (Cout) are outputted.

Thus, for example, the Y exposure part 13Y performs an exposure operation based on the area coverage-converted yellow image signal (Cout). The M exposure part 13M performs an exposure operation based on the area coverage-converted magenta image signal (Cout). The C exposure part 13C performs an exposure operation based on the area coverage-converted cyan image signal (Cout). The K exposure part 13K performs an exposure operation based on the area coverage-converted black image signal (Cout).

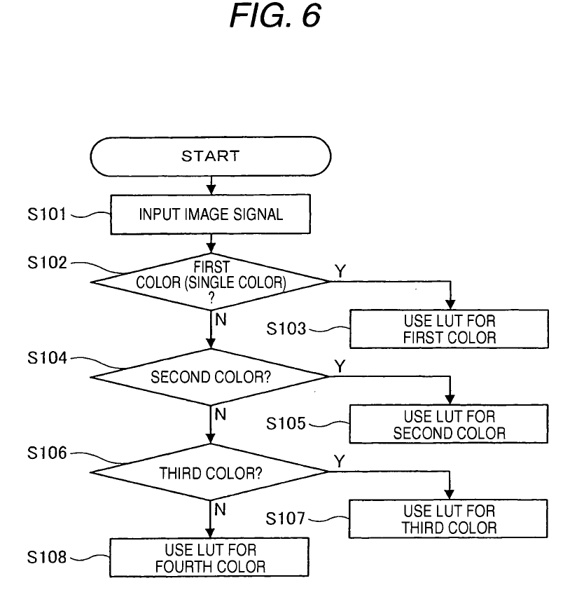

Now, the processing in the image information judging part 76 will be described with reference to the flowchart of FIG. 6.

As an image signal having a predetermined address appended thereto is inputted to the image information judging part 76 (step 101), the image information judging part 76 first judges whether the image signal of this address contains a first color (single color) or not (step 102). If it is judged that the image signal of this address contains a first color, the image information judging part 76 outputs an instruction to decide the use of the first LUT 81a (LUT for first color) to the LUT switching instructing part 77 (step 103).

On the other hand, if it is judged at step 102 that the image signal of this address does not contain a first color, the image information judging part 76 now judges whether the image signal of this address contains a second color or not (step 104). If it is judged that the image signal of this address contains a second color, the image information judging part 76 outputs an instruction to decide the use of the second LUT 81b (LUT for second color) to the LUT switching instructing part 77 (step 105).

Meanwhile, if it is judged at step 104 that the image signal of this address does not contain a second color, the image information judging part 76 now judges whether the image signal of this address contains a third color or not (step 106). If it is judged that the image signal of this address contains a third color, the image information judging part 76 outputs an instruction to decide the use of the third LUT 81c (LUT for third color) to the LUT switching instructing part 77 (step 107). On the other hand, if it is judged at step 106 that the image signal of this address does not contain a third color, the image information judging part 76 determines that the image signal of this address contains a fourth color and outputs an instruction to decide the use of the fourth LUT 81d (LUT for fourth color) to the LUT switching instructing part 77 (step 108). This processing is sequentially performed for each image signal of each address.

In this processing, if the input coverage Cin of each color in an image signal of a certain address is 0% (that is, if no toner image is formed for this address), the use of the LUT for fourth color is decided in the Y-LUT 72, M-LUT 73, C-LUT 74 and K-LUT 75. In this case, however, since the image signals of the respective colors inputted to the Y-LUT 72, M-LUT 73, C-LUT 74 and K-LUT 75 corresponding to this address are zero, there is no problem.

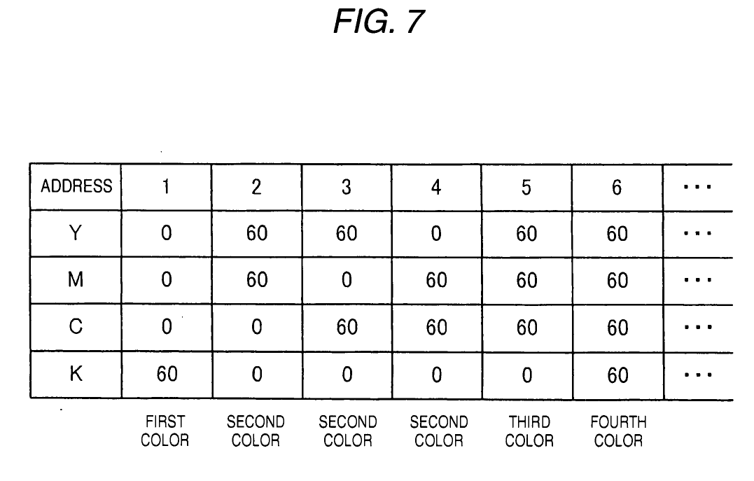

Now, the above-described processing will be described in detail, using a specific example. FIG. 7 shows an exemplary image signal inputted to the image processing part 70 from the image output part 61. As described above, the image signal includes the address for each pixel and area coverage information (Cin) of Y, M, C and K forming the pixel. Here, in the example shown in FIG. 7, a pixel of address 1 contains a first color that is a single color of black, and pixels of addresses 2 to 4 contain second colors of Y+M, Y+C, and M+C. A pixel of address 5 contains a third color of Y+M+C, and a pixel of address 6 contains a fourth color of Y+M+C+K.

Here, a case of forming a red image with an image density of 60% will be considered. Red is formed by superposing a yellow toner and a magenta toner. In this case, the image signal (Y(Cin 60%)+M(Cin 60%)) shown at address 2 in FIG. 7 is inputted to the image processing part 70 from the image output part 61.

The color separation processing part 71 performs color separation of the incoming image signal of address 2 and outputs Y(Cin 60%), M(Cin 60%), C(Cin 0%) and K(Cin 0%) as image signals of the respective colors corresponding to address 2.

Meanwhile, the image information judging part 76 performs judgment processing based on the flowchart shown in FIG. 6, to the incoming image signal of address 2. In this example, since the image signal of address 2 contains the two colors of Y and M, the use of the LUT for second color is designated. Then, the LUT switching instructing part 77 outputs an instruction signal to the effect that the LUT for second color should be used for the image signal of address 2, to the Y-LUT 72, M-LUT 73, C-LUT 74 and K-LUT 75.

In the Y-LUT 72, the LUT acquiring part 82 takes out the second LUT 81b (Y-LUT for second color shown in FIG. 4B) from the LUT storage 81 and outputs it to the LUT processing part 83. In the M-LUT 73, the LUT acquiring part 82 takes out the second LUT 81b (M-LUT for second color shown in FIG. 5B) from the LUT storage 81 and outputs it to the LUT processing part 83.

The yellow image signal (Cin 60%) of address 2 is inputted to the LUT processing part 83 of the Y-LUT 72. The LUT processing part 83 of the Y-LUT 72 refers to the second LUT 81b (Y-LUT for second color shown in FIG. 4B) received from the LUT acquiring part 82 and outputs an output gradation level of 156 corresponding to the input coverage Cin 60% (gradation level of 153) of the yellow image signal, as an area coverage-converted yellow image signal. The magenta image signal (Cin 60%) of address 2 is inputted to the LUT processing part 83 of the M-LUT 73. The LUT processing part 83 of the M-LUT 73 refers to the second LUT 81b (M-LUT for second color shown in FIG. 5B) received from the LUT acquiring part 82 and outputs an output gradation level of 160 corresponding to the input coverage Cin 60% (gradation level of 153) of the magenta image signal, as an area coverage-converted magenta image signal. Since both of the cyan image signal and black image signal of address 2 have the input coverage Cin of 0%, their output gradation levels remain zero.

In the yellow unit 10Y, an electrostatic latent image corresponding to the output gradation level of 156 is formed by the Y exposure part 13Y and the formed electrostatic latent image is developed with a yellow toner, thereby forming a yellow toner image. In the magenta unit 10M, an electrostatic latent image corresponding to the output gradation level of 160 is formed by the M exposure part 13M and the formed electrostatic latent image is developed with a magenta toner, thereby forming a magenta toner image.

In the cyan unit 10C and the black unit 10K, since the output gradation level is zero, no electrostatic latent image is formed by the C exposure part 13C or the K exposure part 13K. Therefore, no cyan toner image or black toner image is developed.

After that, the yellow toner image formed in the yellow unit 10Y is first-transferred to a position corresponding to address 2 on the intermediate transfer belt 20. Then, the magenta toner image formed in the magenta unit 10M is similarly first-transferred to a position corresponding to address 2 on the intermediate transfer belt 20. That is, the magenta toner image is superposed on the yellow toner image on the intermediate transfer belt 20. Since cyan and black toner images are not formed, they are not transferred onto the intermediate transfer belt 20. The yellow and magenta toner images superposed on the intermediate transfer belt 20 are second-transferred to a paper P and fixed by the fixing device 50. The yellow and magenta toner images are thus mixed with each other to form a red image.

In this case, in the yellow unit 10Y, the yellow toner image is formed with the image density increased by 2% (equivalent to a gradation level difference of 3 (=156−153)), anticipating increase in the quantity of residual toner due to insufficient transfer or excessive transfer in the first transfer and second transfer. Also in the magenta unit 1 OM, the magenta toner image is formed with the image density increased by 5% (equivalent to a gradation level difference of 7 (=160−153)), anticipating increase in the quantity of residual toner due to insufficient transfer or excessive transfer in the first transfer and second transfer. Therefore, on the paper P after fixation, a red image with a density of 60% containing the yellow toner with a density of 60% and the magenta toner with a density of 60% is formed. That is, as the above-described color conversion processing is performed to carry out image formation, the coloring deviation in the image that is ultimately formed on the paper P can be restrained.

As described above, in this exemplary embodiment, the color information before color separation is judged, that is, it is judged how many colors (color of what order) are used for forming each pixel constituting an image. On the basis of the result of the judgment, the corresponding LUT is selected and color conversion processing is performed using the selected LUT. Thus, the coloring deviation can be restrained without performing correction using the DLUT. Also, in this exemplary embodiment, the configuration of the image processing part 70 can be simplified, compared with the case of using a DLUT. Since the LUT used for color conversion processing in this exemplary embodiment is one-dimensional, the preparation of the LUT takes less time and labor than the preparation of the DLUT, and the memory storing the data can have a smaller capacity.

While an address is appended in advance to each pixel of an image signal outputted from the PC 60 in this exemplary embodiment, the way of appending an address is not limited to this. For example, an address may be appended to each image signal after the image signal is inputted to the image processing part 70 and before the image signal is inputted to the color separation processing part 71 and the image information judging part 76.

### Second Exemplary Embodiment

This exemplary embodiment is substantially similar to the first exemplary embodiment. However, this exemplary embodiment differs from the first exemplary embodiment in that the LUT to be used is determined in accordance with the sum value (called total Dt) of area coverage of each color constituting each pixel in the first exemplary embodiment, while in this exemplary embodiment, the LUT to be used is determined in accordance with the number of colors that constitute each pixel in the image information judging part 76. In this exemplary embodiment, the same parts as in the first exemplary embodiment are denoted by the same numerals and will not be described further in detail.

In the image forming apparatus, the input coverage of each color of Y, M, C and K of a certain pixel is set within the range of 0 to 100%. Therefore, the minimum value of the total Dt is 0% (=Y(Cin 0%)+M(Cin 0%)+C(Cin 0%)+K(Cin 0%)) and the maximum value is 400% (=Y(Cin 100%)+M(Cin 100%)+C(Cin 100%)+K(Cin 100%)).

In this exemplary embodiment, four LUTs are stored in the LUT storage 81 of each of the Y-LUT 72, M-LUT 73, C-LUT 74 and K-LUT 75, as in the first exemplary embodiment. Here, the first LUT 81a is used when the total Dt is less than 100%. The second LUT 81b is used when the total Dt is equal to or larger than 100% and less than 200%. The third LUT 81c is used when the total Dt is equal to or larger than 200% and less than 300%. The fourth LUT 81d is used when the total Dt is equal to or larger than 300%.

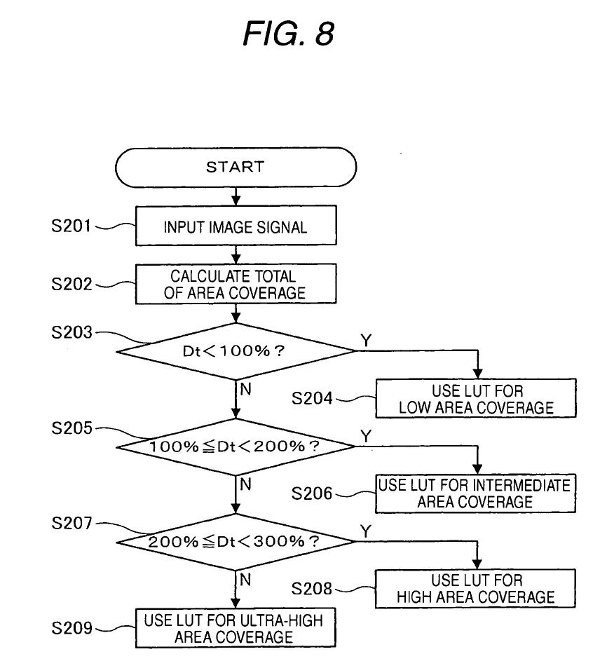

Now, the processing in the image information judging part 76 will be described with reference to the flowchart of FIG. 8.

As an image signal having a predetermined address appended thereto is inputted to the image information judging part 76 (step 201), the image information judging part 76 first calculates the total Dt of area coverage in the image signal of this address (step 202). Next, the image information judging part 76 judges whether the total Dt of area coverage is less than 100% or not (step 203). If it is judged here that the total Dt of area coverage is less than 100%, the image information judging part 76 outputs an instruction to decide the use of the first LUT 81a (LUT for low area coverage) to the LUT switching instructing part 77 (step 204).

On the other hand, if it is judged at step 203 that the total Dt of area coverage is not less than 100%, the image information judging part 76 then judges whether the total Dt of area coverage is equal to or larger than 100% and less than 200% (step 205). If it is judged here that the total Dt of area coverage is equal to or larger than 100% and less than 200%, the image information judging part 76 outputs an instruction to decide the use of the second LUT 81b (LUT for intermediate area coverage) to the LUT switching instructing part 77 (step 206).

If it is judged at step 205 that the total Dt of area coverage is not equal to or larger than 100% and less than 200%, the image information judging part 76 then judges whether the total Dt of area coverage is equal to or larger than 200% and less than 300% (step 207). If it is judged here that the total Dt of area coverage is equal to or larger than 200% and less than 300%, the image information judging part 76 outputs an instruction to decide the use of the third LUT 81c (LUT for high area coverage) to the LUT switching instructing part 77 (step 208). On the other hand, if it is judged at step 207 that the total Dt of area coverage is not equal to or larger than 200% and less than 300%, the image information judging part 76 determines that the total Dt of area coverage is equal to or larger than 300% and outputs an instruction to decide the use of the fourth LUT 81d (LUT for ultra-high area coverage) to the LUT switching instructing part 77 (step 209). This processing is sequentially performed for each image signal of each address.

Then, in the Y-LUT 72, M-LUT 73, C-LUT 74 and K-LUT 75, color conversion processing is performed to the incoming image signal of each color by using the LUT (one of the first to fourth LUTs 81a to 81d) decided by the above-described procedure.

In this exemplary embodiment, the image density information before color separation is judged, that is, it is judged what amount of toner (corresponding to total Dt) is used for constituting respective pixels forming an image. On the basis of the result of this judgment, the corresponding LUT is selected and color conversion processing is performed using the selected LUT. Thus, as in the first exemplary embodiment, the coloring deviation can be restrained without performing correction using a DLUT.

Particularly in this exemplary embodiment, since the LUT is selected on the basis of the total Dt of area coverage of each pixel, the coloring deviation in the formed image can be further restrained by setting a large correction amount, for example, in the case of a high-density image where insufficient transfer or excessive transfer of toners can easily occur.

### Third Exemplary Embodiment

This exemplary embodiment is substantially similar to the second exemplary embodiment. However, this exemplary embodiment differs from the second exemplary embodiment in that, in the second exemplary embodiment, the LUT to be used is determined in accordance with the sum value (total Dt) of area coverage of each color constituting each pixel, whereas in this exemplary embodiment, the LUT to be used is determined in accordance with the sum value of area coverage of each color that is already formed as a toner image and transferred on the intermediate transfer belt 20 before the toner image of the color of interest is transferred (the sum value is called total Db), of the total Dt. In this exemplary embodiment, the same parts as in the exemplary embodiments 1 and 2 are denoted by the same numerals and will not be described further in detail.

In this exemplary embodiment, four LUTs are stored in the LUT storage 81 of each of the Y-LUT 72, M-LUT 73, C-LUT 74 and K-LUT 75, as in the exemplary embodiments 1 and 2. Here, the first LUT 81a is used when the total Db is less than 100%. The second LUT 81b is used when the total Db is equal to or larger than 100% and less than 200%. The third LUT 81c is used when the total Db is equal to or larger than 200% and less than 300%. The fourth LUT 81d is used when the total Db is equal to or larger than 300%.

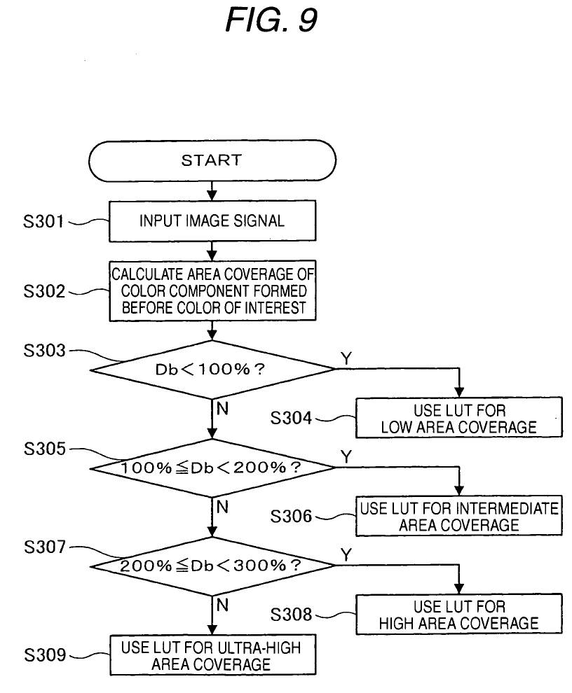

Now, the processing in the image information judging part 76 will be described with reference to the flowchart of FIG. 9. In this exemplary embodiment, this processing is performed for each color of yellow, magenta, cyan and black.

As an image signal having a predetermined address appended thereto is inputted to the image information judging part 76 (step 301), the image information judging part 76 first calculates the total of area coverage of each color that is already formed as a toner image and transferred on the intermediate transfer belt 20 before the toner image of the color of interest is transferred, namely, the total Db (for example, yellow and magenta if the color of interest is cyan), from the image density of each color in the image signal of this address (step 302). Next, the image information judging part 76 judges whether the total Db is less than 100% or not (step 303). If it is judged here that the total Db is less than 100%, the image information judging part 76 outputs an instruction to decide the use of the first LUT 81a (LUT for low area coverage) to the LUT switching instructing part 77 (step 304).

On the other hand, if it is judged at step 303 that the total Db is not less than 100%, the image information judging part 76 then judges whether the total Db is equal to or larger than 100% and less than 200% (step 305). If it is judged here that the total Db is equal to or larger than 100% and less than 200%, the image information judging part 76 outputs an instruction to decide the use of the second LUT 81b (LUT for intermediate area coverage) to the LUT switching instructing part 77 (step 306).

If it is judged at step 305 that the total Db is not equal to or larger than 100% and less than 200%, the image information judging part 76 then judges whether the total Db is equal to or larger than 200% and less than 300% (step 307). If it is judged here that the total Db is equal to or larger than 200% and less than 300%, the image information judging part 76 outputs an instruction to decide the use of the third LUT 81c (LUT for high area coverage) to the LUT switching instructing part 77 (step 308). On the other hand, if it is judged at step 307 that the total Db is not equal to or larger than 200% and less than 300%, the image information judging part 76 determines that the total Db is equal to or larger than 300% and outputs an instruction to decide the use of the fourth LUT 81d (LUT for ultra-high area coverage) to the LUT switching instructing part 77 (step 309). This processing is sequentially performed for each image signal of each address.

Then, in the Y-LUT 72, M-LUT 73, C-LUT 74 and K-LUT 75, color conversion processing is performed to the incoming image signal of each color by using the LUT (one of the first to fourth LUTs 81a to 81d) decided by the above-described procedure.

In this exemplary embodiment, it is judged what mount of toner (corresponding to the total Db) is used for the other colors formed before the color of interest in each pixel that forms an image, from the image density information before color separation. On the basis of the result of this judgment, the corresponding LUT is selected and color conversion processing is performed using the selected LUT. Thus, as in the first exemplary embodiment, the coloring deviation can be restrained without performing correction using a DLUT.

In this exemplary embodiment, the LUT to be used is decided on the basis of the total Db, which is the sum value of image densities of the color components formed before the color of interest. However, the way of deciding the LUT to be used is not limited to this. For example, the LUT to be used can also be decided on the basis of the sum value of image densities of the color of interest and the color components formed before the color of interest.

In the exemplary embodiments 1 to 3, the setting of image forming conditions is changed by changing the LUT to be used. However, the change of the setting is not limited to this. For example, the condition of charging by the charging roll 12, the condition of exposure by the exposure part 13, the condition of development by the developer 14, the condition of first transfer by the first transfer roll 15 and the like can be directly changed.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
a separator that separates an input image signal including a plurality of color signals to each color corresponding to a marking engine of each color and outputs a color signal of each color;
an acquiring part that acquires contents of the plurality of color signals forming each pixel from the input image signal; and
a setting part that sets an image forming condition for each color by using the color signal of each color outputted from the separator and the contents of the plurality of color signals outputted from the acquiring part.

2. The image processing system as claimed in claim 1, wherein a color space of the plurality of color signals forming the input image signal is the same as a color space of an image outputted by the marking engine of each color.

3. The image processing system as claimed in claim 1, wherein the acquiring part acquires at least one of a combination of colors to be used and the number of colors to be used, as the contents of the plurality of color signals.

4. The image processing system as claimed in claim 1, wherein the acquiring part acquires at least one of area coverage of each color and a total of area coverage of each color, as the contents of the plurality of color signals.

5. The image processing system as claimed in claim 1, wherein the setting part sets the image forming condition by using one of lookup tables each associating an input coverage and an output coverage in a one-to-one manner, and
the one of lookup tables used by the setting part is determined on the basis of the contents of the plurality of color signals.

6. An image processing system comprising:
a separator that separates an input image signal including a plurality of color signals to each color corresponding to a marking engine of each color and outputs a color signal of each color;
a converter that performs density conversion to the color signal of each color outputted from the separator, by using a predetermined parameter;
an acquiring part that acquires contents of the plurality of color signals forming each pixel from the input image signal; and
a switcher that switches the predetermined parameter used by the converter for performing density conversion, in accordance with the contents of the plurality of color signals acquired by the acquiring part.

7. The image processing system as claimed in claim 6, wherein the acquiring part acquires the number of colors forming each pixel as the contents of the plurality of color signals and determines the predetermined parameter on the basis of the acquired number of colors.

8. The image processing system as claimed in claim 6, wherein the acquiring part acquires a total of area coverage of each color forming each pixel as the contents of plurality of color signals and determines the predetermined parameter on the basis of the acquired total of area coverage.

9. The image processing system as claimed in claim 6, wherein the converter performs density conversion to the color signal of each color using a lookup table associating an input coverage and an output coverage in a one-to-one manner, and
the switcher switches the lookup table to be used by the converter as the predetermined parameter.

10. The image processing system as claimed in claim 6, wherein the switcher switches the predetermined parameter for each pixel of the input image signal, and
the converter performs density conversion to the color signal of the corresponding pixel by using the predetermined parameter.

11. An image processing method comprising:
separating an input image signal including a plurality of color signals to each color corresponding to a marking engine of each color and outputting a color signal of each color;
acquiring contents of the plurality of color signals forming each pixel from the input image signal; and
setting an image forming condition for each color by using the color signal of each color and the contents of the plurality of color signals.

12. The image processing method as claimed in claim 11, wherein a color space of the plurality of color signals forming the input image signal is the same as a color space of an image outputted by the marking engine of each color.

13. The image processing method as claimed in claim 11, wherein at least one of a combination of colors to be used and the number of colors to be used is acquired as the contents of the plurality of color signals.

14. The image processing method as claimed in claim 11, wherein at least one of area coverage of each color and a total of area coverage of each color is acquired as the contents of the plurality of color signals.

15. The image processing method as claimed in claim 11, wherein the image forming condition is set by using one of lookup tables each associating an input coverage and an output coverage in a one-to-one manner, and
the one of lookup tables to be used is determined on the basis of the contents of the plurality of color signals.
